(19) United States
(12) Patent Application Publication
(10) Pub. No.: US 2026/0012816 A1
(43) Pub. Date: Jan. 8, 2026

(54) OUT-OF-BAND CONTROL OF BASE STATION SYSTEMS

(71) Applicant: Charter Communications Operating, LLC, St. Louis, MO (US)

(72) Inventors: Faisal Khan, Aurora, CO (US); Lakhbir Singh, Aurora, CO (US)

(21) Appl. No.: 18/762,231

(22) Filed: Jul. 2, 2024

(51) Int. Cl. H04W 24/04; H04W 24/08; H04W 88/08

(52) U.S. Cl. CPC H04W 24/04; H04W 24/08; H04W 88/08

(57) ABSTRACT

A wireless controller is communicatively coupled to a base station that includes a first communications interface operable to communicate with an upstream computing device and a second wireless communications interface operable to communicate with a client device via wireless signals. The wireless controller receives, via a long-range wireless communications interface, an instruction to cause the base station to one of power-on, power-off and reboot. The wireless controller, responsive to receipt of the instruction, causes the base station to one of power-on, power-off and reboot.

### BACKGROUND

In order to provide broad geographic cellular coverage it is often necessary for a service provider to install base stations in remote locations that may be far from technicians. Diagnosing and resolving problems often requires a technician to travel quite some distance to the base station.

### SUMMARY

The examples disclosed herein implement a relatively low cost but highly reliable mechanism for diagnosing and controlling a base station without the need to dispatch a technician when a backhaul failure occurs, reducing costs, increasing uptime of the base station, and reducing the possibility of injury to a technician.

In one example a base station system is provided. The base station system includes a base station that includes a first communications interface operable to communicate with an upstream computing device and a second wireless communications interface operable to communicate with a client device via wireless signals. The base station system further includes a wireless controller communicatively coupled to the base station. The wireless controller includes a long-range wireless communications interface. The wireless controller is operable to receive, via the long-range wireless communications interface, an instruction to cause the base station to one of power-on, power-off and reboot. The wireless controller is further operable to, responsive to the instruction, cause the base station to one of power-on, power-off and reboot.

In another example a method is provided. The method includes receiving, by a wireless controller communicatively coupled to a base station that comprises a first communications interface operable to communicate with an upstream computing device and a second wireless communications interface operable to communicate with a client device via wireless signals, via a long-range wireless communications interface, an instruction to cause the base station to one of power-on, power-off and reboot. the method further includes, responsive to receipt of the instruction, cause, by the wireless controller, the base station to one of power-on, power-off and reboot.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment suitable for implementing out-of-band control of base station systems according to some implementations; and

FIG. 2 is a flowchart of a method for out-of-band control of base station systems according to some implementations.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

In order to provide broad geographic cellular coverage it is often necessary for a service provider to install base stations in remote locations far from technicians. A base station typically has two communication paths. A first communication interface connects the base station to a core network of the service provider. This is sometimes referred to as a backhaul connection or a backhaul link, or simply backhaul. The first communication interface may be wired and utilize, for example, a fiber cable, an Ethernet cable, a coaxial cable, or may be a point-to-point wireless communications interface. A second communications interface is a wireless interface that utilizes wireless signals to implement a cellular service, such as 3G, 4G, 5G or the like with end user devices, such as cell phones and the like.

If the backhaul link goes down the core network can no longer communicate with the base station. A technician is then dispatched to the base station to diagnose the problem. This is a relatively costly activity, and in situations where the technician has to climb an antenna or otherwise interact with high-voltage equipment, or travel during inclement weather, may expose the technician to bodily injury. Moreover, physical access to base stations may require certain access permissions that increases the delay in resolving the problem. Any of these factors can lead to increased base station downtime and customer dissatisfaction. Often, however, all that is needed is for the technician to restart/reboot the base station to resolve the problem.

The examples disclosed herein implement a base station system that includes a wireless controller that utilizes a long-range wireless technology, such as, by way of non-limiting example, LoRaWAN, an official standard of the International Telecommunication Union (ITU), ITU-T Y.4480. The wireless controller can communicate with the service provider’s network and obtain telemetry data from the base station and provide the telemetry data to the service provider’s network even if the base station is not responding. The wireless controller can also send instructions to, or otherwise cause the base station to reboot, power down, power up, or restart. The wireless controller may utilize a long range, low power and low bit rate wireless protocol and may thus have relatively low power requirements. The wireless controller may, in some implementations, be battery operated and thus utilize a power supply that is separate from that of the base station to which the wireless controller is communicatively coupled. It is noted that LoRaWan is simply one example of a suitable low power long-range wireless technology, and other low power long-range wireless technologies may be utilized, such as, by way of non-limiting example, Sigfox, Wise, or NB-IoT low power long-range wireless technologies.

The examples disclosed herein implement a relatively low cost but highly reliable mechanism for diagnosing and controlling a base station without the need to dispatch a technician when a backhaul failure occurs, reducing costs, increasing uptime of the base station, and reducing the possibility of injury to a technician.

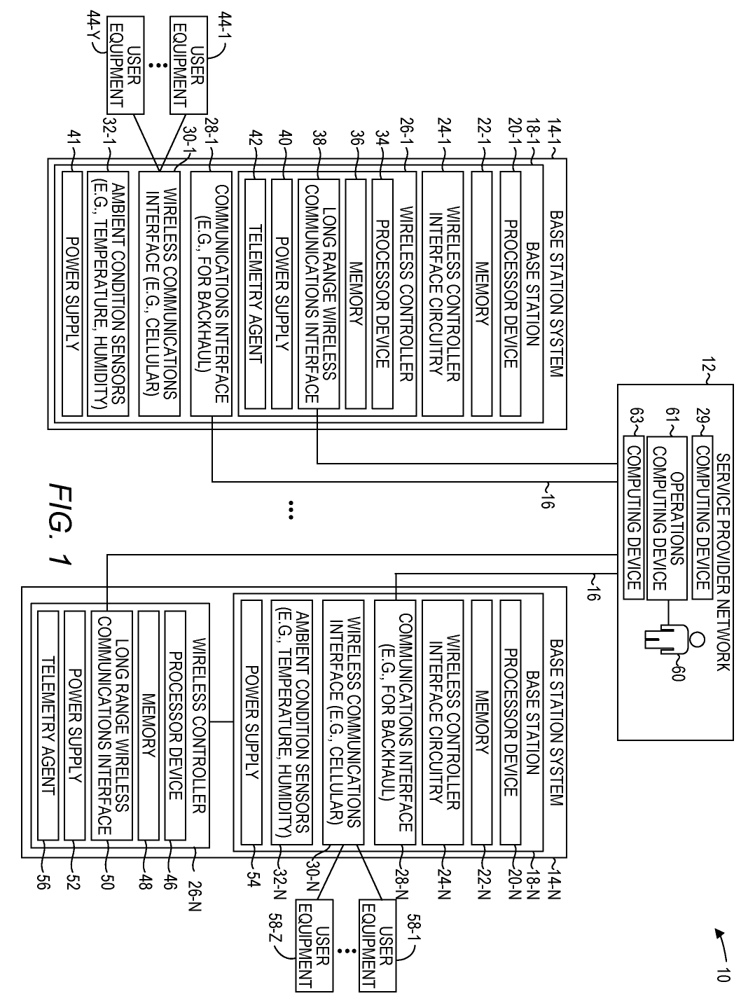

FIG. 1 is a block diagram of an environment 10 suitable for implementing out-of-band control of base station systems according to some implementations. The term “out-of-band” in this context refers to a communications path that is separate from and implemented with different communication interfaces than a backhaul communications path. The environment 10 includes a service provider network 12 which is communicatively coupled to a plurality of base station systems 14-1 – 14-N (generally, base station systems 14). The service provider network 12 communicates with the base station systems 14 over a plurality of backhaul links 16-1 – 16-N (generally, backhaul links 16), respectively. The backhaul links 16 may comprise any suitable relatively high-bandwidth communication links, such as fiber, Ethernet, coaxial, wireless point-to-point, or the like. The backhaul links 16 transport data received from user equipments (UEs) that are destined typically for devices external to the service provider network 12, such as the Internet. The backhaul links 16 also transport data received from devices external to the service provider network 12, such as the Internet, to the UEs. The service provider network 12 may include any number of computing devices, such as switches, routers, servers, operational computing devices, fiber aggregation nodes, cable modem termination systems, and the like.

The base station system 14-1 includes a base station 18-1 that includes a processor device 20-1, a memory 22-1, wireless controller interface circuitry 24-1, a wireless controller 26-1, a communications interface 28-1, a communications interface 30-1 and one or more ambient condition sensors 32-1.

In this example, the wireless controller 26-1 is integrated with the base station 18-1. For example, the wireless controller 26-1 may comprise circuitry on the same motherboard as the base station 18-1, or otherwise be tightly coupled to the base station 18-1. The wireless controller 26-1 includes a processor device 34 and a memory 36. The wireless controller 26-1 includes a long range wireless communications interface 38 via which the wireless controller 26-1 can communicate with the service provider network 12. In some implementations the long range wireless communications interface 38 utilizes a wireless communications protocol having an effective range of greater than two kilometers. In some implementations the long range wireless communications interface 38 utilizes a LoRaWan wireless communications protocol, a standard of the International Telecommunication Union (ITU), ITU-T Y.4480. In some implementations the long range wireless communications interface 38 utilizes a chirp spread spectrum (CSS) modulation technology. The long range wireless communications interface 38 may comprise a low bit rate communications channel, such as, by way of non-limiting example, 0.3 kbit/s to 50 kbit/s per channel, and thus may not be suitable for backhaul purposes. The service provider network 12 has one or more computing devices with corresponding long range wireless communications interfaces suitable for communicating with the long range wireless communications interface 38. In some implementations, the wireless controller 26-1 is an Internet-of-Things (IoT) device.

Because the wireless controller 26-1 utilizes a low-power long range communications interface, the wireless controller 26-1 may, in some implementations, be powered by a battery power supply 40 that is separate from a power supply 41 that provides power to the base station 18-1. The wireless controller 26-1 may include a telemetry agent 42 operable to obtain telemetry data about and/or from the base station 18-1. Such telemetry information may include, by way of non-limiting example, temperature data indicative of an internal temperature of the base station 18-1 obtained from an ambient condition sensor 30-1, humidity data indicative of an internal humidity of the base station 18-1 obtained from an ambient condition sensor 30-1, signal strength data indicative of a signal strength of the base station 18-1, and power level data indicative of a power level of the base station 18-1.

The wireless controller interface circuitry 24-1 is control circuitry designed to interface with the wireless controller 26-1. In particular, the wireless controller interface circuitry 24-1 may receive instructions from the wireless controller 26-1 and implement the instructions, such as power-on instructions, power-off instruction, restart/reboot instructions, and the like. The wireless controller interface circuitry 24-1 may also communicate telemetry data of the base station 18-1 to the wireless controller 26-1 periodically, intermittently, or upon request from the wireless controller 26-1.

The communications interface 28-1 (e.g., a first communications interface) implements the backhaul link 16 with the service provider network 12, and is operable to communicate with an upstream computing device 29 in the service provider network 12. The communications interface 28-1 may comprise, for example, a fiber communications interface, an Ethernet communications interface, a coaxial communications interface, or any other suitable high-bandwidth communications interface suitable for rapidly transferring large quantities of data to and from UEs. The upstream computing device 29 may comprise, for example, a cable modem termination system, a server computing device, or the like. There may be any number of devices, such as routers, switches, or the like between the upstream computing device 29 and the base station 18-1.

The wireless communications interface 30-1 (e.g., second wireless communications interface) is operable to communicate with one or more client devices via wireless signals, such as a plurality of UEs 44-1 – 44-Y (generally, UEs 44). The UEs 44 may comprise, for example, smart phones, laptop computers with cellular transceivers, computing tablets with cellular transceivers, automobiles with cellular transceivers, or the like. The wireless communications interface 30-1 implements a cellular wireless service, such as a 3G cellular wireless service, 4G cellular wireless service, 5G cellular wireless service or the like with the UEs 44.

The base station system 14-N is substantially similar to the base station system 14-1 except as otherwise discussed herein. The base station system 14-N includes a base station 18-N that includes a processor device 20-N, a memory 22-N, wireless controller interface circuitry 24-N, a wireless controller 26-N, a communications interface 28-N, a communications interface 30-N and one or more ambient condition sensors 32-N.

In this example, the wireless controller 26-N is physically separate from the base station 18-N but communicates with the base station 18-N using a suitable communications mechanism wherein when the base station 18-N is operational the base station 18-N can respond to instructions and/or requests from the wireless controller 26-N, such as requests for telemetry data, requests to reboot, and the like. The wireless controller 26-N includes a processor device 46 and a memory 48. The wireless controller 26-N includes a long range wireless communications interface 50 via which the wireless controller 26-N can communicate with the service provider network 12. Similar to the wireless controller 26-1, the long range wireless communications interface 50 utilizes a wireless communications protocol having an effective range of greater than two kilometers, and may comprise, for example, a LoRaWan wireless communications protocol, a standard of the ITU, ITU-T Y.4480. In some implementations the long range wireless communications interface 50 utilizes a CSS modulation technology. The long range wireless communications interface 50 may comprise a low bit rate communications channel, such as, by way of non-limiting example, 0.3 kbit/s to 50 kbit/s per channel, and thus may not be suitable for backhaul purposes.

Because the wireless controller 26-N utilizes a low-power long range communications interface, the wireless controller 26-N may, in some implementations, be powered by a battery power supply 52 that is separate from a power supply 54 that provides power to the base station 18-N. The wireless controller 26-N may include a telemetry agent 56 operable to obtain telemetry information about and/or from the base station 14-N. Such telemetry information may include, by way of non-limiting example, temperature data indicative of an internal temperature of the base station 14-N obtained from an ambient condition sensor 30-N, humidity data indicative of an internal humidity of the base station 14-N obtained from an ambient condition sensor 30-N, signal strength data indicative of a signal strength of the base station 14-N, and power level data indicative of a power level of the base station 14-N.

The communications interface 28-N (e.g., a first communications interface) implements the backhaul link 16 with the service provider network 12, and is operable to communicate with an upstream computing device in the service provider network 12. The communications interface 28-N may comprise, for example, a fiber communications interface, an Ethernet communications interface, a coaxial communications interface, or any other suitable high-bandwidth communications interface suitable for rapidly transferring relatively large quantities of data to and from UEs.

The wireless communications interface 30-N (e.g., second wireless communications interface) is operable to communicate with one or more client devices via wireless signals, such as a plurality of UEs 58-1 – 58-Z (generally, UEs 58). The wireless communications interface 30-N implements a cellular wireless service, such as a 3G cellular wireless service, 4G cellular wireless service, 5G cellular wireless service or the like with the UEs 58.

With this background, examples of out-of-band control of base station systems will be discussed with regard to the base station system 14-1. It is noted however that the examples are equally applicable to the base station system 14-N. In a first example, an operator 60 via an operations computing device 61, or a program running on a computing device 63 in the service provider network 12, may intermittently, periodically, or in response to some event, send a request to the wireless controller 26-1 for telemetry data of the base station 18-1. The wireless controller 26-1 receives the request via the long range wireless communications interface 38. The telemetry agent 42 may send a request to the wireless controller interface circuitry 24-1 requesting the telemetry data. The wireless controller interface circuitry 24-1 may access the ambient condition sensors 32-1 and provide the telemetry data to the telemetry agent 42. The wireless controller interface circuitry 24-1 may also access any suitable internal information maintained by the base station 18-1 such as, by way of non-limiting example, the number of UEs 44 currently being serviced by the base station 18-1, the signal strength with each such UE 44, locations of the UEs 44, and the like, and provide such telemetry data to the telemetry agent 42. The telemetry agent 42 sends the telemetry data to the requesting computing device in the service provider network 12 via the long range wireless communications interface 38.

In some implementations the telemetry agent 42 may have direct access to query the ambient condition sensors 32-1 such that the telemetry agent 42 can provide ambient condition telemetry data to the service provider network 12 via the long range wireless communications interface 38 even if the base station 18-1 is non-responsive.

In a second example, the operator 60, via the operations computing device 61, sends an instruction to the wireless controller 26-1 to cause the base station 18-1 to perform an action, such as power-off, reboot or restart. The wireless controller 26-1 receives the instruction via the long range wireless communications interface 38. The wireless controller 26-1 may query the wireless controller interface circuitry 24-1 to determine if the wireless controller interface circuitry 24-1 is responsive. If so, the wireless controller 26-1 sends a signal to the wireless controller interface circuitry 24-1 to cause the wireless controller interface circuitry 24-1 to implement the instruction. The wireless controller 26-1 may send an acknowledgement to the operations computing device 61 indicating that the wireless controller 26-1 provided the instruction to the base station 18-1.

If the wireless controller interface circuitry 24-1 is not responsive, the wireless controller 26-1 may interact directly with the power supply 40 to cause an action, such as a power-on command, a power-off command, a reboot command, or the like.

Alternatively, the wireless controller 26-1 may forgo interacting with the wireless controller interface circuitry 24-1 for various instructions. For example, the wireless controller 26-1 may receive a reboot instruction via the long range wireless communications interface 38 to cause the base station 18-1 to reboot, and in response, the wireless controller 26-1 interacts with the power supply 40 to cause the power supply to shut power off to the base station 18-1. After a predetermined period of time, the wireless controller 26-1 interacts with the power supply 40 to cause the power supply to resume power to the base station 18-1. It is noted that the wireless controller 26-N operates substantially similarly to control the base station 14-N as described herein with regard to the wireless controller 26-1 and the base station 14-1.

In some implementations, the operator 60 may query the wireless controller 26-1 to obtain a status of the base station 18-1. The wireless controller 26-1 may request a status from the wireless controller interface circuitry 24-1. The wireless controller interface circuitry 24-1 may determine that the base station 18-1 is operating normally, and the wireless controller 26-1 may inform the operations computing device 61 that the base station 18-1 is operating normally. Alternatively, the wireless controller interface circuitry 24-1 may not respond, and the wireless controller 26-1 may inform the operations computing device 61 that the base station 18-1 is non-responsive.

In some implementations the wireless controller 26-1 may periodically poll the wireless controller interface circuitry 24-1 to obtain a status of the base station 18-1. The period may comprise, for example, every second, every five seconds, every ten seconds, or other suitable or desired period of time. If, based on the response from the wireless controller interface circuitry 24-1, or lack thereof, the wireless controller 26-1 may inform the service provider network 12 that the base station 18-1 is, or appears to be, non-responsive.

It is noted that, while for purposes of illustration functionality has been attributed to the wireless controller 26-1, certain or all of such functionality may be implemented by instructions executed by the processor device 34 and thus such functionality may similarly be attributed to the processor device 34 in such implementations.

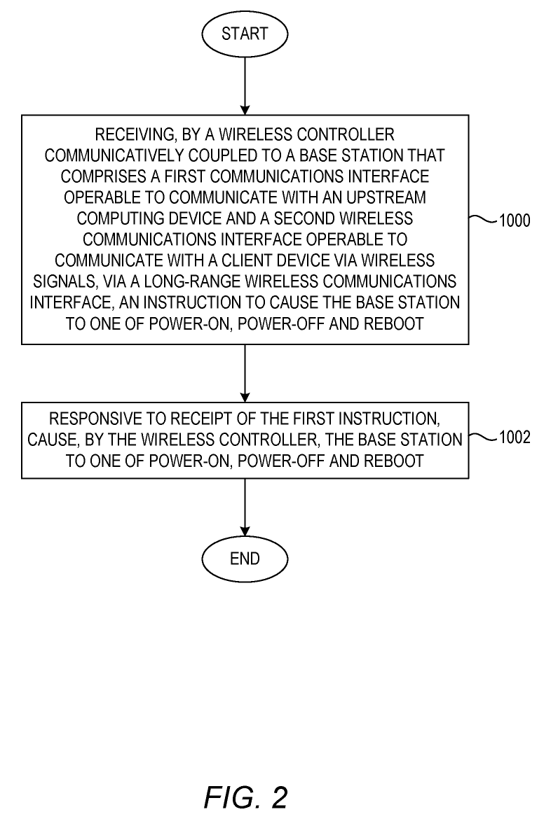

FIG. 2 is a flowchart of a method for out-of-band control of base station systems according to some implementations. FIG. 2 will be discussed in conjunction with FIG. 1. The wireless controller 26-1, communicatively coupled to the base station 18-1 that includes the first communications interface 28-1 operable to communicate with the upstream computing device 29 and the second wireless communications interface 30-1 operable to communicate with the client devices 44 via wireless signals, receives via the long-range wireless communications interface 38 an instruction to cause the base station 18-1 to one of power-on, power-off and reboot (FIG. 2, block 1000). Responsive to receipt of the instruction, the wireless controller 26-1 causes the base station 18-1 to one of power-on, power-off and reboot (FIG. 2, block 1002).

Individuals will recognize improvements and modifications to the preferred examples of the disclosure. All such improvements and modifications are considered within the scope of the concepts disclosed herein and the claims that follow.

What is claimed is:

1. A base station system, comprising:
a base station, comprising:
a first communications interface operable to communicate with an upstream computing device; and
a second wireless communications interface operable to communicate with a client device via wireless signals;
a wireless controller communicatively coupled to the base station, comprising:
a long-range wireless communications interface;
wherein the wireless controller is operable to:
receive, via the long-range wireless communications interface, an instruction to cause the base station to one of power-on, power-off and reboot; and
responsive to the instruction, cause the base station to one of power-on, power-off and reboot.

2. The base station system of claim 1, wherein the long-range wireless communications interface utilizes a wireless communications protocol having an effective range of greater than two kilometers.

3. The base station system of claim 1, wherein the long-range wireless communications interface utilizes a LoRaWan wireless communications protocol.

4. The base station system of claim 1, wherein the second wireless communications interface is a cellular wireless communications interface.

5. The base station system of claim 1, wherein the first communications interface is one of a fiber communications interface, an Ethernet communications interface, and a coaxial communications interface.

6. The base station system of claim 1, wherein the wireless controller is further operable to:
receive, via the long-range wireless communications interface from a computing device, a request to obtain telemetry data of the base station;
obtain the telemetry data of the base station; and
send, to the computing device via the long-range wireless communications interface, the telemetry data.

7. The base station system of claim 6, wherein the telemetry data comprises at least one of temperature data indicative of an internal temperature of the base station, signal strength data indicative of a signal strength of the base station, and power level data indicative of a power level of the base station.

8. The base station system of claim 1, wherein the long-range wireless communications interface utilizes a chirp spread spectrum (CSS) modulation technology.

9. The base station system of claim 1, wherein to cause the base station to one of power-on, power-off and reboot, the wireless controller is operable to send a signal to control circuitry of the base station.

10. The base station system of claim 1, wherein to cause the base station to one of power-on, power-off and reboot, the wireless controller is operable to control a power supply of the base station to cause the base station to one of power-on, power-off and reboot.

11. A method, comprising:
receiving, by a wireless controller communicatively coupled to a base station that comprises a first communications interface operable to communicate with an upstream computing device and a second wireless communications interface operable to communicate with a client device via wireless signals, via a long-range wireless communications interface, an instruction to cause the base station to one of power-on, power-off and reboot; and
responsive to receipt of the instruction, cause, by the wireless controller, the base station to one of power-on, power-off and reboot.

12. The method of claim 11, wherein the long-range wireless communications interface utilizes a wireless communications protocol having an effective range of greater than two kilometers.

13. The method of claim 11, wherein the long-range wireless communications interface utilizes a LoRaWan wireless communications protocol.

1414 The method of claim 11, wherein the second wireless communications interface is a cellular wireless communications interface.

15. The method of claim 11, wherein the first communications interface is one of a fiber communications interface, an Ethernet communications interface, and a coaxial communications interface.

16. The method of claim 11, further comprising:
receiving, by the wireless controller via the long-range wireless communications interface from a computing device, a request to obtain telemetry data of the base station;
obtaining the telemetry data of the base station; and
sending, by the wireless controller to the computing device via the long-range wireless communications interface, the telemetry data.

17. The method of claim 16, wherein the telemetry data comprises at least one of temperature data indicative of an internal temperature of the base station, signal strength data indicative of a signal strength of the base station, and power level data indicative of a power level of the base station.

18. The method of claim 11, wherein the long-range wireless communications interface utilizes a chirp spread spectrum (CSS) modulation technology.

19. The method of claim 11, wherein causing the base station to one of power-on, power-off and reboot, further comprises sending, by the wireless controller, a signal to control circuitry of the base station.

20. The method of claim 11, wherein causing the base station to one of power-on, power-off and reboot, further comprises controlling, by the wireless controller, a power supply of the base station to cause the base station to one of power-on, power-off and reboot.
